(19) United States
(12) Patent Application Publication
(10) Pub. No.: US 2014/0015815 A1
(43) Pub. Date: Jan. 16, 2014

(54) DISPLAY DEVICE AND SOURCE DRIVER THEREOF

(71) Applicant: RAYDIUM SEMICONDUCTOR CORPORATION, Hsinchu City (TW)

(72) Inventor: KAI-LAN CHUANG, TAINAN CITY (TW)

(73) Assignee: RAYDIUM SEMICONDUCTOR CORPORATION, Hsinchu City (TW)

(21) Appl. No.: 13/655,402

(22) Filed: Oct. 18, 2012

(30) Foreign Application Priority Data
Jul. 16, 2012 (TW) 101125569

(51) Int. Cl. G06F 3/038

(52) U.S. Cl. 345/204

(57) ABSTRACT

The present invention discloses a display device and its source driver comprising a plurality of data lines, a selection module, and a plurality of channel groups. The selection module receives a plurality of first data signals from the data lines, rearranges the first data signals in a first mode or a second mode according to a mode control signal, and outputs a plurality of second data signals accordingly. The channel groups transmit the second data signals outputted by the selection module, and each channel group has a first channel unit and a second channel unit. The first channel unit and the second channel unit of any of the channel groups respectively receives the different second data signals in the first mode, and the first channel unit and the second channel unit of any of the channel groups respectively receives the same second data signal in the second mode.

### BACKGROUND OF THE INVENTION

1. Field of the Invention

The present invention relates to a display device and a source driver thereof; in particular, to a display device and a source driver which can operate in different driving types.

2. Description of Related Art

With the development of photoelectric and semiconducting technique, planar display devices are commonly used nowadays. Among the planar display devices, the liquid crystal displayer is quickly accepted by customers because it occupies small space and comes along with the properties of low energy consumption, zero radiation, and low EMI.

The thin film transistor liquid crystal display (TFT-LCD) is a well-known type of the liquid crystal displayer, and the drivers of the TFT-LCD mainly includes a source driver and a gate driver.

In tradition, each pixel cell of a display panel is coupled to a scan line of the gate driver and a data line of the source driver (which is known as 1D1G structure), but the 1D1G structure may usually have distortion problem with large visual angle. In order to solve the aforementioned problem, each pixel cell of a display panel can be separated into two sub-pixel cells, and the sub-pixel cells can be coupled to the same scan line of the gate driver and different data lines of the source driver (which is known as 2D1G structure).

However, it is necessary that the designer should confirm whether the TFT-LCD is designed under 1D1G structure or 2D1G structure before designing the source driver of the TFT-LCD. For example, if the TFT-LCD is designed under 1D1G structure, the source driver of the TFT-LCD shall be adapted to 1D1G structure. Besides, if the TFT-LCD is designed under 2D1G structure, the source driver of the TFT-LCD shall be adapted to 2D1G structure. Therefore, a source driver which can be switched for adapting 1D1G structure or 2D1G structure is needed to reduce the manufacture cost.

### SUMMARY OF THE INVENTION

The object of the present invention is to provide a source driver having a selection module that a first channel unit and a second channel unit of a channel group electrically connected to the selection module can receive different or identical data signals selectively, so that the source driver, controlled by a time controller, can be switched for adapting 1D1G structure or 2D1G structure.

In order to achieve the aforementioned objects, according to an embodiment of the present invention, a source driver is provided. The source driver comprises a plurality of data lines, a selection module, and a plurality of channel groups. The plurality of data lines transmit a plurality of first data signals. The selection module receives the first data signals, rearranges the first data signals in a first mode or in a second mode according to a mode control signal, and outputs a plurality of second data signals accordingly. The plurality of channel groups transmit the second data signals outputted by the selection module, and each of the channel groups has a first channel unit and a second channel unit. The first channel unit and the second channel unit of any of the channel groups respectively receives the different second data signals in the first mode, and the first channel unit and the second channel unit of any of the channel groups respectively receives the same second data signal in the second mode.

The object of the present invention is to provide a display device which has a source driver having a selection module that a first channel unit and a second channel unit of a channel group electrically connected to the selection module can receive different or identical data signals selectively, so that the source driver, controlled by a time controller, can be switched for adapting 1D1G structure or 2D1G structure.

In order to achieve the aforementioned objects, according to an embodiment of the present invention, a display device is provided. The display device comprises a time controller, a source driver, and a display panel. The time controller provides a plurality of first data signals and a control signal. The source driver comprises a plurality of data lines, a selection module, and a plurality of channel groups. The plurality of data lines transmit a plurality of first data signals. The selection module receives the first data signals, rearranges the first data signals in a first mode or in a second mode according to a mode control signal, and outputs a plurality of second data signals accordingly. The plurality of channel groups transmit the second data signals outputted by the selection module, and each of the channel groups has a first channel unit and a second channel unit. The first channel unit and the second channel unit of any of the channel groups respectively receives the different second data signals in the first mode, and the first channel unit and the second channel unit of any of the channel groups respectively receives the same second data signal in the second mode. The display panel receives the second data signals outputted by the channel groups.

To sum up, the disclosed display device and the source driver can process different or identical data signals by the selection of the selection module, so that the source driver, controlled by a time controller, can be switched for adapting 1D1G structure or 2D1G structure.

In order to further the understanding regarding the present invention, the following embodiments are provided along with illustrations to facilitate the disclosure of the present invention.

### BRIEF DESCRIPTION OF THE DRAWINGS

FIG. 1 shows a block diagram of a display device according to an embodiment of the present invention;

FIG. 2 shows a block diagram of the source driver operated in 1D1G mode according to an embodiment of the present invention;

FIG. 3 shows a block diagram of the source driver operated in 2D1G mode according to an embodiment of the present invention;

FIG. 4 shows a block diagram of the source driver according to another embodiment of the present invention;

FIG. 5A shows a block diagram of the second register operated in 1D1G mode according to another embodiment of the present invention;

FIG. 5B shows a block diagram of the second register operated in 2D1G mode according to another embodiment of the present invention.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

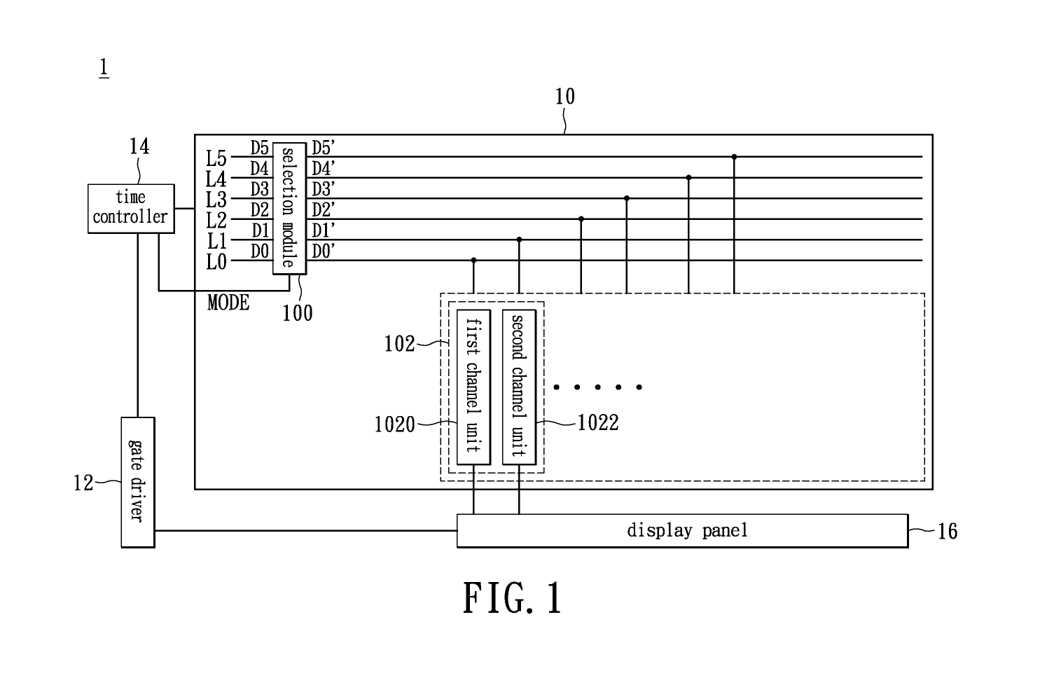

Please referred to FIG. 1, FIG. 1 shows a block diagram of a display device according to an embodiment of the present invention. As shown in FIG. 1, the display device 1 includes a source driver 10, a gate driver 12, a time controller 14, and a display panel 16. The time controller 14 is respectively coupled to the source driver 10 and the gate driver 12, and the display panel 16 is coupled to the output ends of the source driver 10 and the gate driver 12. Besides, the gate driver 12, the time controller 14, and the display panel 16 are well known by those skilled in the art, the embodiment of the present invention will not describe them for simplicity.

The source driver 10 includes a plurality of data lines L0-L5, a selection module 100, and a plurality of channel groups 102, and the selection module 100 is coupled to the data lines L0-L5. The data lines L0-L5 can transmit a plurality of data signals D0-D5 which is outputted from the time controller 14 to the selection module 100. For example, the data signal DO can be transmitted by the data line L0, the data signal D1 can be transmitted by the data line L1, etc.. Besides, the time controller 14 can provide a mode control signal MODE for controlling the selection module 100, so that the selection module 100 can rearrange the data signals D0-D5 and output rearranged data signals D0′-D5′ accordingly. In other words, the selection module 100 can decide which pattern (e.g., first mode or second mode) should the or data signals D0-D5 be in rearranged.

The plurality of channel groups 102 can transmit the data signals D0′-D5′ outputted from the selection module 100. Each of the channel groups 102 has a first channel unit 1020 and a second channel unit 1022.

Therefore, by controlling the selection module 100, the first channel unit 1020 and the second channel unit 1022 of any of the channel groups 102 can respectively receive the same data signals in a preset mode (e.g. 2D1G mode), such as the first channel unit 1020 and the second channel unit 1022 can both receive the same data signal D0′. Moreover, the first channel unit 1020 and the second channel unit 1022 of any of the channel groups 102 can respectively receive the different data signals in another preset mode (e.g. 1D1G mode), such as the first channel unit 1020 and the second channel unit 1022 can respectively receive the data signal D0′ and the data signal D1′. Thus, the source driver 10 can be adapted to the display panel 16 using either 1D1G structure or 2D1G structure.

To be noted, although the present invention illustrates and discloses 6 data lines L0-L5 and 6 channel groups 102a-102f, but it should not be limited to the specific number of the data lines and the channel groups of the source driver 10.

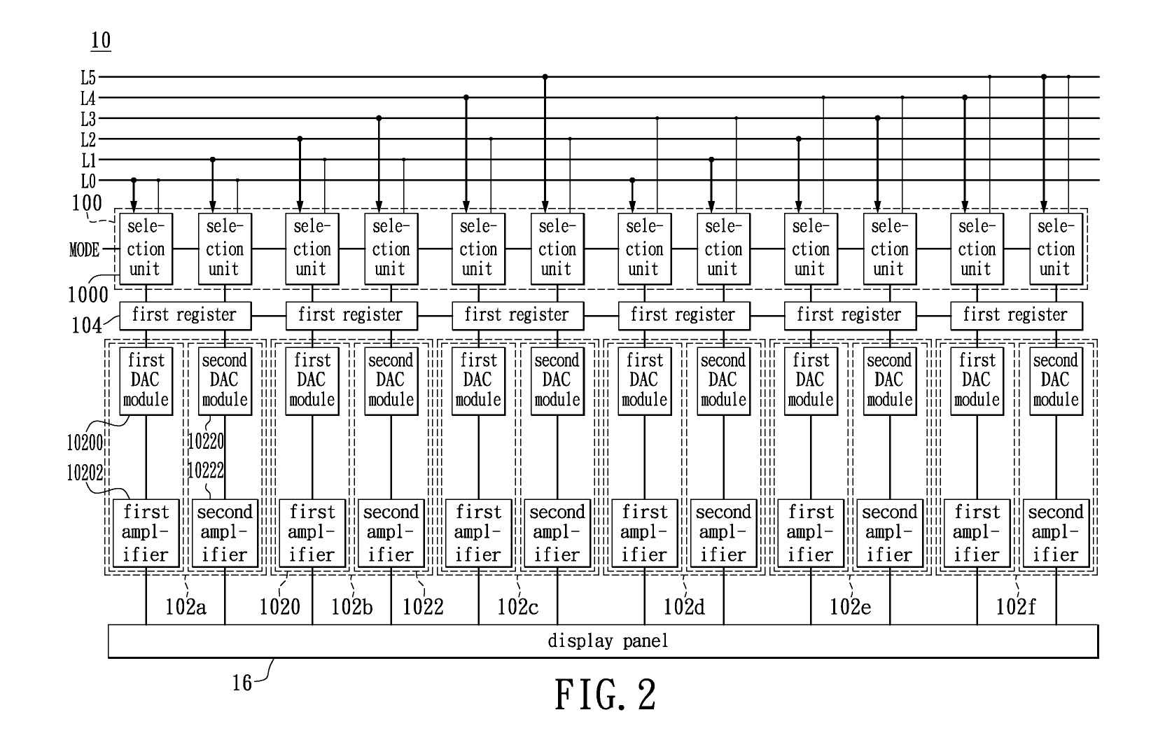

Please referred to FIG. 2, FIG. 2 shows a block diagram of the source driver operated in 1D1G mode according to an embodiment of the present invention. As shown in FIG. 2, there are a plurality of selection units 1000 disposed in the selection module 100, two input ends of each selection unit 1000 are designed to be coupled to the same data line or two different data lines. For example, there are two selection unit 1000 corresponding to the channel group 102a, left input ends of the two selection unit 1000 are respectively coupled to the data line L0 and the data line L1, and right input ends of the two selection unit 1000 are both coupled to the data line L0. Similarly, left input ends of the two selection unit 1000 corresponding to the channel group 102b are respectively coupled to the data line L2 and the data line L3, and right input ends of the two selection unit 1000 are both coupled to the data line L1.

Each selection unit 1000 is controlled by the mode control signal MODE to decide which input end should be conducted, so that the corresponding data signals D0′-D5′ can be outputted accordingly. For example, the mode control signal MODE can control every selection units 1000 to conduct their left or right input end, and different data signals can pass through the selection units 1000 accordingly. In practice, the selection unit 1000 can be, but not limited to, a 2-to-1 multiplexer (MUX). Thus, the left input end of each selection unit 1000 can be conducted when the source driver 10 is operated in 1D1G mode, and the right input end of each selection unit 1000 can be conducted when the source driver 10 is operated in 2D1G mode.

The source driver 10 can further have a plurality of first registers 104. Each first register 104 is coupled to the output ends of the corresponding selection units 1000, and coupled to the input ends of the first channel unit 1020 and the second channel unit 1022, respectively. Therefore, each first register 104 can directly output 2 data signals to the first channel unit 1020 and the second channel unit 1022, respectively, or each first register 104 can also swap 2 data signals before outputting to the first channel unit 1020 and the second channel unit 1022, respectively.

In practice, for those skilled in the art could understand that the first register 104 can have a data latch, a 2-to-2 switch unit, and a voltage lifting unit, the embodiment of the present invention will not describe them for simplicity. To be noted, the 2-to-2 switch unit can be controlled by a POL signal transmitted from the time controller 14, so that the first register 104 can directly output 2 data signals to the first channel unit 1020 and the second channel unit 1022, respectively, or each first register 104 can also swap 2 data signals before outputting to the first channel unit 1020 and the second channel unit 1022, respectively.

Besides, as shown in FIG. 2, each channel group 102 can has a first DAC module 10200, a second DAC module 10220, a first amplifier 10202, and a second amplifier 10222, and the data signals outputted from the first DAC module 10200 and the second DAC module 10220 can be transmitted to the display panel 16. In practice, the first DAC module 10200 and the second DAC module 10220 can be, but not limited to, a p-type MOSFET and a n-type MOSFET, respectively. The function of each channel group 102 shall be well-known for those skilled in the art, the embodiment of the present invention will not describe the channel group 102 for simplicity.

Specifically, the data lines L0-L5 can transmits a plurality of data signals D0-D5 which is outputted from the time controller 14, each data line can be sequentially connected to several selection units 1000, and each selection unit 1000 can receive one or two data signals transmitted from the connected data lines. When the selection units 1000 are triggered by the mode control signal MODE and operated in 1D1G mode, the left input end of each selection unit 1000 can be conducted, and the corresponding data signal can be transmitted to the first register 104. Therefore, the data signals outputted from the first channel units 1020 and the second channel units 1022 of the channel groups 102a-102f of the source driver 10 can be arranged in D0′, D1′, D2′, D3′, D4′, D5′. D0′, D1′, D2′, D3′, D4′, D5′. Obviously, the source driver 10 of the present invention can be adapted to the display panel 16 using 1D1G structure.

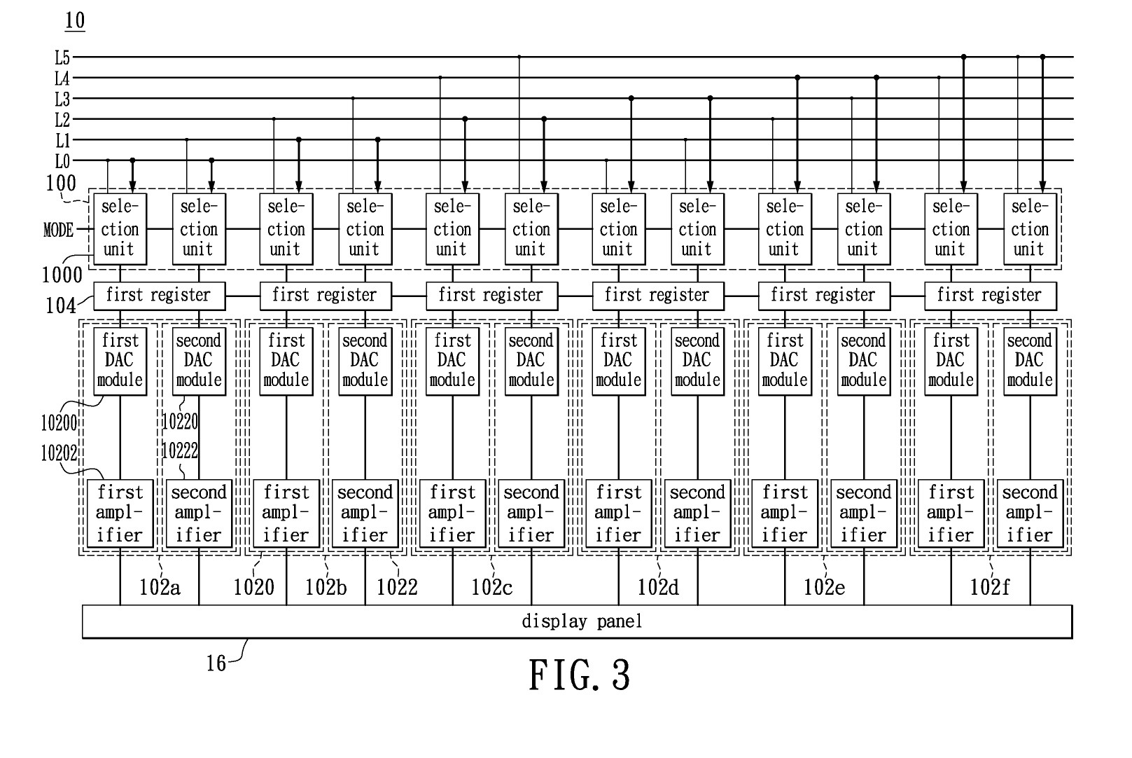

Please referred to FIG. 3, FIG. 3 shows a block diagram of the source driver operated in 2D1G mode according to an embodiment of the present invention. As shown in FIG. 3, when the selection units 1000 are triggered by the mode control signal MODE and operated in 2D1G mode, the right input end of each selection unit 1000 can be conducted, and the corresponding data signal can be transmitted to the first register 104. Therefore, the data signals outputted from the first channel units 1020 and the second channel units 1022 of the channel groups 102a-102f of the source driver 10 can be arranged in D0′, D0′, D1′, D1′, D2′, D2′. D3′, D3′, D4′, D4′, D5′, D5′. Obviously, the source driver 10 of the present invention can be adapted to the display panel 16 using 2D1G structure.

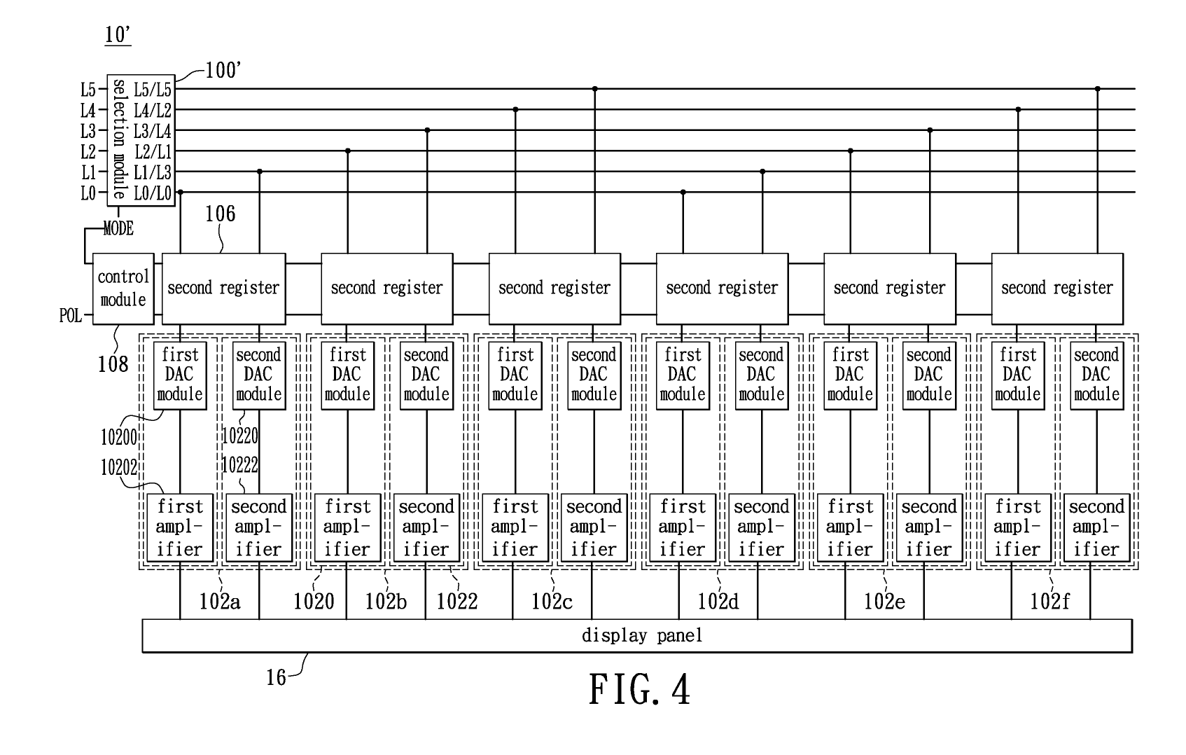

Please referred to FIG. 4, FIG. 4 shows a block diagram of the source driver according to another embodiment of the present invention. As shown in FIG. 4, the input end of the selection module 100′ of the source driver 10′ is also coupled to the data lines L0-L5, and the selection module 100′ is also controlled by the mode control signal MODE outputted from the time controller 14. However, it is different from the previous embodiment of the present invention that the selection module 100′ is connected to the input ends of the data lines L0-L5, but the selection module 100 of the previous embodiment is connected to the output ends of the data lines L0-L5.

The mode control signal MODE can control the selection module 100′ to be operated in 2 different modes (1D1G mode and 2D1G mode) that can rearrange the received data signals D0-D5 in a specific sequence. For example, in 1D1G mode, the selection module 100′ does not swap the data signals D0-D5, so that the selection module 100′ will not swap the data signal D0′ in the data line L0, thus the data signals D0′-D5′ outputted from the selection module 100′ will be the same as the data signals D0-D5 inputted to the selection module 100′. In 2D1G mode, the selection module 100′ swaps the data signals D0-D5, for example, the selection module 100′ swaps the received data signal D1 and outputs the received data signal D1 in the data line L3 as the data signal D1′; the selection module 100′ swaps the received data signal D2 and outputs the received data signal D2 in the data line L1 as the data signal D2′; the selection module 100′ swaps the received data signal D3 and outputs the received data signal D3 in the data line L4 as the data signal D3′; the selection module 100′ swaps the received data signal D4 and outputs the received data signal D4 in the data line L2 as the data signal D4′; the selection module 100′ does not swap the received data signal D0 and D5 so that the data signals D0 and D5 outputted from the selection module 100′ will be the same as the data signals D0 and D5 inputted to the selection module 100′.

In addition, the source driver 10′ can further have a plurality of second registers 106 and a control module 108, and the second registers 106 are coupled between the control module 108, the channel groups 102a-102f, and the output end of the selection module 100′. The control module 108 can control the data path within the second registers 106 according to the mode control signal MODE and a POL signal. Specifically, each second registers 106 receives two of the data signals D0′-D5′ outputted from the selection module 100′, then selectively outputs the received data signals to the corresponding first channel unit 1020 and the second channel unit 1022, respectively, or outputs only one of the received data signals to both of the corresponding first channel unit 1020 and the second channel unit 1022.

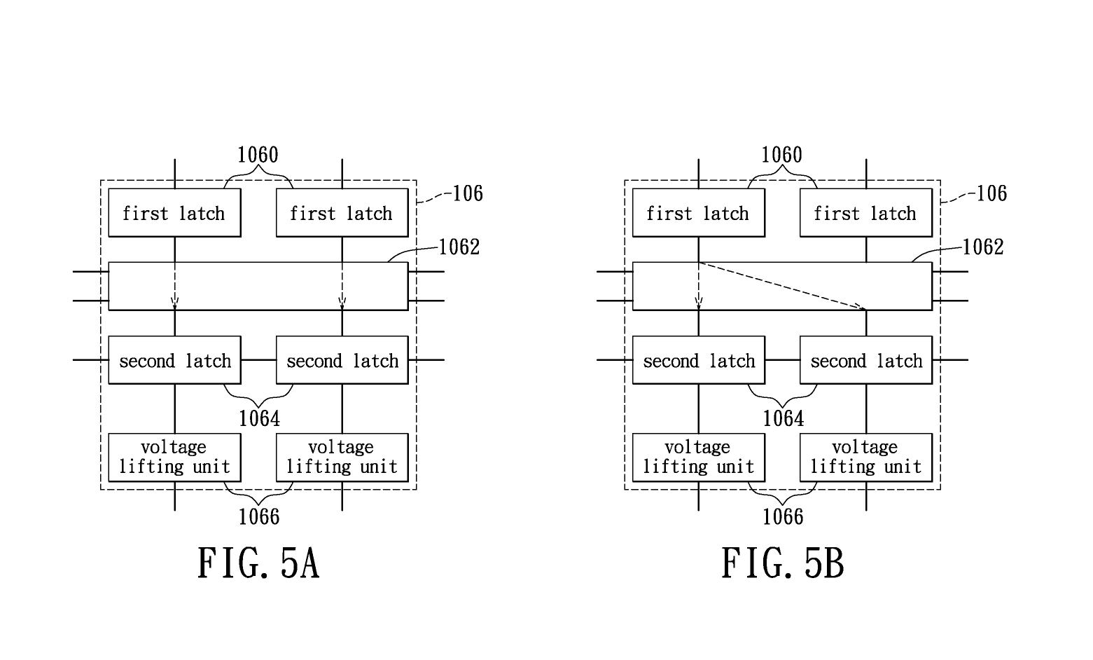

In practice, the selection module 100′ could be, but not limited to, a data bus mapping circuit, and the control module 108 could be, but not limited to, a logic circuit. In order to describe how the data signals transmitted within the second registers 106, please referred to FIGS. 5A and 5B, FIG. 5A shows a block diagram of the second register operated in 1D1G mode according to another embodiment of the present invention, and FIG. 5B shows a block diagram of the second register operated in 2D1G mode according to another embodiment of the present invention. The same as the first register 104 of the previous embodiment, the second registers 106 can also have a first latch 1060, a 2-to-2 switch unit 1062, a second latch 1064, and a voltage lifting unit 1066.

As shown in FIG. 5A, when the control module 108, coupled to the 2-to-2 switch unit 1062, receives the POL signal and the mode control signal MODE indicating the selection module 100′ shall be operated in 1D1G mode, the two output ends of the 2-to-2 switch unit 1062 will directly transmit the data signals inputted to the two input ends of the 2-to-2 switch unit 1062, respectively.

On the other hand, as shown in FIG. 5B, when the control module 108, coupled to the 2-to-2 switch unit 1062, receives the POL signal and the mode control signal MODE indicating the selection module 100′ shall be operated in 2D1G mode, the two output ends of the 2-to-2 switch unit 1062 will transmit only one of the data signals inputted to the two input ends of the 2-to-2 switch unit 1062, respectively.

Specifically, according to FIG. 4 and FIG. 5A, when the selection module 100′ is triggered by the mode control signal MODE and the POL signal and operated in 1D1G mode, the data signals outputted from the first channel units 1020 and the second channel units 1022 of the channel groups 102a-102f of the source driver 10′ can be arranged in D0′, D1′, D2′, D3′, D4′, D5′. D0′, D1′, D2′, D3′, D4′, D5′. Obviously, the source driver 10′ of the present invention can be adapted to the display panel 16 using 1D1G structure.

Besides, according to FIG. 4 and FIG. 5B, when the selection module 100′ is triggered by the mode control signal MODE and the POL signal and operated in 2D1G mode, the data signals outputted from the first channel units 1020 and the second channel units 1022 of the channel groups 102a-102f of the source driver 10′ can be arranged in D0′, D0′, D1′, D1′, D2′, D2′. D3′, D3′, D4′, D4′, D5′, D5′. Obviously, the source driver 10′ of the present invention can be adapted to the display panel 16 using 2D1G structure.

To sum up, the disclosed display device and the source driver can selectively have its first channel units and its second channel units of the channel groups to receive different or identical data signals by controlling the mode control signal provided by the time controller. Therefore, the source driver, controlled by a time controller, can be switched for adapting 1D1G structure or 2D1G structure.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A source driver, comprising:
a plurality of data lines for transmitting a plurality of first data signals;
a selection module, coupled to the data lines, for receiving the first data signals, rearranging the first data signals in a first mode or in a second mode according to a mode control signal, and outputting a plurality of second data signals accordingly; and
a plurality of channel groups for transmitting the second data signals outputted by the selection module, and each of the channel groups having a first channel unit and a second channel unit, wherein the first channel unit and the second channel unit of any of the channel groups respectively receives the different second data signals in the first mode, and the first channel unit and the second channel unit of any of the channel groups respectively receives the same second data signal in the second mode.

2. The source driver according to claim 1, wherein the selection module has a plurality of selection units, the selection units are coupled to at least one of the data lines, and each of the selection units selectively outputs the second data signal carried by one of the data lines electrically connected to the corresponding selection unit according to the mode control signal.

3. The source driver according to claim 2, wherein the source driver further comprises a plurality of first registers, each of the first registers, coupled to two of the selection units, receives the second data signals outputted by the corresponding selection units, and selectively outputs the unchanged second data signals or the swapped second data signals to the corresponding first channel unit and the corresponding second channel unit.

4. The source driver according to claim 1, wherein the source driver further comprises a plurality of second registers coupled between the channel groups and an output end of the selection module, each of the second registers receives two of the second data signals outputted by the selection module, and selectively outputs both of the received second data signals to the corresponding first channel unit and the corresponding second channel unit, respectively, or outputs only one of the received second data signals to both of the corresponding first channel unit and the corresponding second channel unit.

5. The source driver according to claim 4, wherein the second registers are coupled to a control module for controlling the second data signals outputted by the second registers according to the mode control signal.

6. A display device, comprising:
a time controller for providing a plurality of first data signals and a control signal;
a source driver, coupled to the time controller, comprising:
a plurality of data lines for transmitting the first data signals;
a selection module, coupled to the data lines, for receiving the first data signals, rearranging the first data signals in a first mode or in a second mode according to a mode control signal, and outputting a plurality of second data signals accordingly; and
a plurality of channel groups for transmitting the second data signals outputted by the selection module, and each of the channel groups having a first channel unit and a second channel unit,
wherein the first channel unit and the second channel unit of any of the channel groups respectively receives the different second data signals in the first mode, and the first channel unit and the second channel unit of any of the channel groups respectively receives the same second data signal in the second mode;
a display panel for receiving the second data signals outputted by the channel groups.

7. The display device according to claim 6, wherein the selection module has a plurality of selection units, the selection units are coupled to at least one of the data lines, and each of the selection units selectively outputs the second data signal carried by one of the data lines electrically connected to the corresponding selection unit according to the mode control signal.

8. The display device according to claim 7, wherein the source driver further comprises a plurality of first registers, each of the first registers, coupled to two of the selection units, receives the second data signals outputted by the corresponding selection units, and selectively outputs the unchanged second data signals or the swapped second data signals to the corresponding first channel unit and the corresponding second channel unit.

9. The display device according to claim 6, wherein the source driver further comprises a plurality of second registers coupled between the channel groups and an output end of the selection module, each of the second registers receives two of the second data signals outputted by the selection module, and selectively outputs both of the received second data signals to the corresponding first channel unit and the corresponding second channel unit, respectively, or outputs only one of the received second data signals to both of the corresponding first channel unit and the corresponding second channel unit.

10. The display device according to claim 9, wherein the second registers are coupled to a control module for controlling the second data signals outputted by the second registers according to the mode control signal.
